(19) United States
(12) Patent Application Publication
(10) Pub. No.: US 2026/0331881 A1
(43) Pub. Date: Oct. 22, 2026

(54) DEAD-FRONT OVERHEAD TRANSFORMER AND CABLE ASSEMBLY

(71) Applicant: Eaton Intelligent Power Limited, Dublin (IE)

(72) Inventors: Samuel T. Reed, Hartland, WI (US); James S. Washburn, Waukesha, WI (US); Hugo Parra, Nacogdoches, TX (US); Daniel Pinto, Nacogdoches, TX (US); Ismael Naja, Nacogdoches, TX (US); Ricardo Figueroa, Zapopan (MX); Marian Colorado, Santiago de Querétaro (MX); Andrew Schroeder, Waukesha, WI (US)

(21) Appl. No.: 19/637,327

(22) Filed: Apr. 2, 2026

Related U.S. Application Data
(60) Provisional application No. 63/784,640, filed on Apr. 7, 2025.

(51) Int. Cl. H02B 7/06; H02B 1/20; H02B 1/46; H02G 3/22

(52) U.S. Cl. CPC H02B 7/06; H02B 1/20; H02B 1/46; H02G 3/22

(57) ABSTRACT

An overhead transformer includes: a housing that defines an interior; at least one dead-front bushing that is accessible from an exterior of the housing, the dead-front bushing including an electrically insulating cover that surrounds an electrical conductor. The overhead transformer also includes a transforming apparatus in the interior, the transforming apparatus electrically connected to the electrical conductor.

### CROSS-REFERENCE TO RELATED APPLICATION

This application claims the benefit of U.S. Provisional Application No. 63/784,640, filed Apr. 7, 2025 and titled DEAD-FRONT OVERHEAD TRANSFORMER AND CABLE ASSEMBLY, which is incorporated herein by reference in its entirety.

### TECHNICAL FIELD

This disclosure relates to a dead-front overhead transformer and a cable assembly.

### BACKGROUND

A transformer includes a main winding and an electromagnetic circuit that delivers current from the main winding to an electric load. An overhead transformer is a transformer that is configured to be mounted off the ground, for example, on an upper portion of a utility pole.

### SUMMARY

In one aspect, an overhead transformer includes: a housing that defines an interior; at least one dead-front bushing that is accessible from an exterior of the housing, the dead-front bushing including an electrically insulating cover that surrounds an electrical conductor. The overhead transformer also includes a transforming apparatus in the interior, the transforming apparatus electrically connected to the electrical conductor.

Implementations may include one or more of the following features.

The overhead transformer may be a single-phase transformer that includes at least one dead-front bushing accessible from the exterior of the housing.

The overhead transformer may be a multi-phase transformer that includes more than two dead-front bushings accessible from the exterior of the housing.

The overhead transformer also may include one or more components configured for high-voltage operation in the interior. The components configured for high-voltage operation may include one or more of an arrester and a fuse.

In another aspect, a cable assembly includes: a dead-front connector configured to mechanically and electrically connect to a bushing on an overhead transformer; and an electrical cable electrically connected to the dead-front connector and to a voltage termination.

Implementations may include one or more of the following features.

The cable assembly also may include an attachment device configured to attach the voltage termination to an overhead power line. The attachment device may include a hot-line stirrup clamp connected to the voltage termination. The voltage termination may include a high-voltage stress cone.

The dead-front connector may include a quarter-turn connector.

The dead-front connector may include a dead-break connector.

The dead-front connector may include a feature configured to interact with a hotstick. Implementations of any of the techniques described herein may a system, an overhead transformer, a cable assembly, or a process. The details of one or more implementations are set forth in the accompanying drawings and the description below. Other features will be apparent from the description and drawings, and from the claims.

### DRAWING DESCRIPTION

FIG. 1 is a block diagram of an electrical system that includes an overhead (OH) transformer.

FIGS. 2A-2C are various views of another OH transformer.

FIG. 3 shows another OH transformer and a cable system.

FIG. 4 is a partial exterior view of an upper portion of another OH transformer.

FIGS. 5A and 5B are perspective views of examples of connectors.

### DETAILED DESCRIPTION

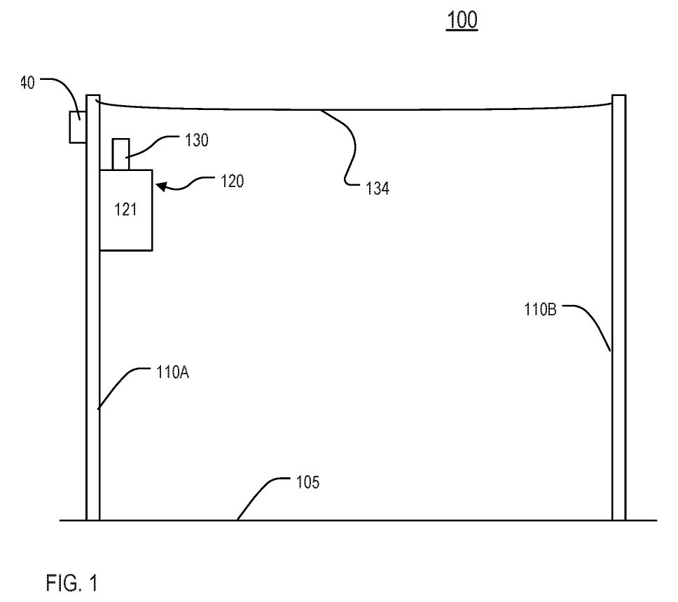

FIG. 1 is a block diagram of an electrical system 100 that includes an overhead (OH) transformer 120. The OH transformer 120 includes a dead-front bushing 130 and/or internalized high-voltage aspects, including high-voltage bushings or connectors, fuses, and/or arresters. The dead-front bushing 130 and/or internalized high-voltage components reduce the risk of fire and the risk of harm to animals that could otherwise occur as a result of internal faults or contact with a live connection.

The system 100 includes supports 110A and 110B that hold an overhead power line 134. Each support 110A, 100B may be, for example, a utility pole, a tower, a frame, or a pylon. The supports 110A, 110B are mounted into a surface 105 and the overhead power line 134 is suspended over the surface 105. The surface 105 may be, for example, the surface of the earth and may partially or completely covered with dirt, grass, gravel, concrete, asphalt, and/or water. The surface 105 may be the surface of a concrete pad or platform that is mounted on the surface of the earth. Although one overhead power line 134 is shown, the supports 110A and 110B may support more than one power line. For example, the system 100 may be a multi-phase electrical grid and the power line 134 may carry electrical power of, for example, 10 kilovolts or greater with a fundamental frequency of 50 Hertz (Hz) or 60 Hz.

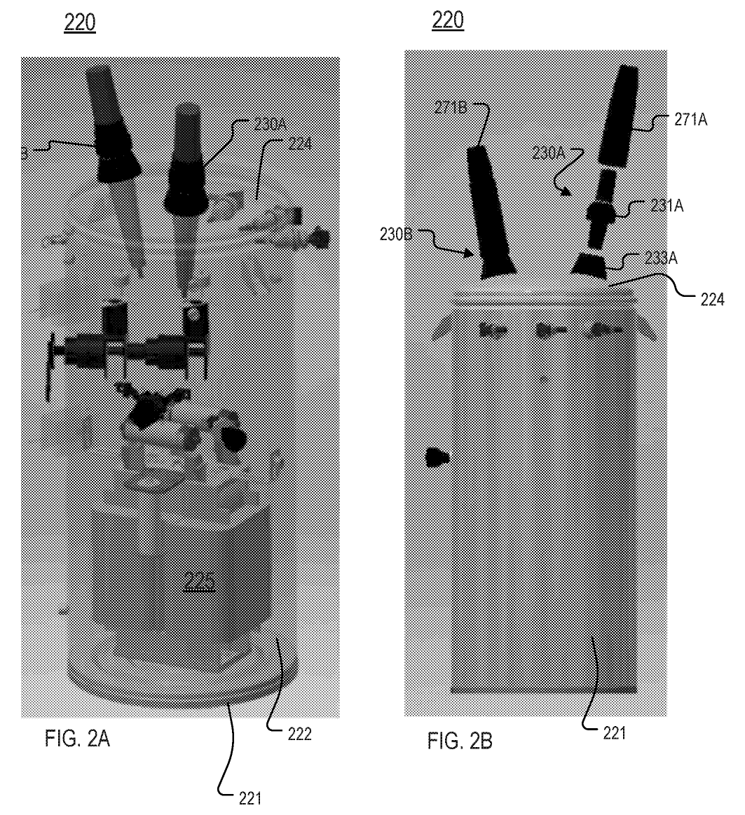

The transformer 120 is mounted to the support 110A and is near the overhead power line 134. The transformer 120 is not accessible by a human from the surface 105 without the use of a device such as a ladder, lift, or crane. The transformer 120 includes a housing 121 and the dead-front bushing 130, which is accessible from an exterior of the housing 121. The bushing 130 is used to electrically connect a transforming apparatus (such as the transforming apparatus 225 of FIG. 2A) in the housing 121 to electrical components 140 and/or to the overhead power line 134. The electrical components 140 may include, for example, fuse(s) and/or arrester(s). In implementations in which the OH transformer 120 includes internalized high-voltage aspects, some or all of the electrical components 140 are located in the housing 121 instead of on the support 110A.

Legacy OH transformers include live-front bushings. A live-front bushing includes an exposed electrical conductor that may be at system potential and may carry live currents. On the other hand, the OH transformer 120 includes the dead-front bushing 130. The dead-front bushing 130 also includes an electrical conductor, but the conductor is enclosed or encased in an electrically insulating housing made of, for example, epoxy, ethylene propylene diene monomer (EPDM) rubber, and/or a nylon resin. Thus, the exterior of the dead-front bushing 130 does not carry electrical current and is not at system potential. In this way, the dead-front bushing 130 reduces or eliminates the risk of harm that could otherwise occur through physical contact with a live bushing.

FIGS. 2A-2C show another OH transformer 220. FIG. 2A is a perspective view of the OH transformer 220 with a housing 221 of the transformer 220 shown as transparent so that an interior 222 of the housing 221 is visible. The housing 221 is generally cylindrical and the interior 222 may be filled with an insulating fluid. The OH transformer 220 includes dead-front bushings 230A and 230B that extend through a top 224 of the housing 221. The dead-front bushings 230A and 230B are electrically connected to a transforming apparatus 225 in the interior 222. The transforming apparatus 225 may be a device that is configured to increase (step up) or decrease (step down) a voltage received at the transforming apparatus 225 and/or a device that is configured to regulate voltage. The transforming apparatus 225 may include an input coil and an output coil that, in use, are magnetically coupled. The transforming apparatus 225 also may include a ferromagnetic core.

FIG. 2B is an exterior perspective view of the OH transformer 220. In FIG. 2B, the dead-front bushing 230A is shown in an exploded perspective view, with a high-voltage dead-break cable termination 271A removed from a bushing insert 231A. The high-voltage dead-break cable termination 271A may be a straight shank connector that is permanently attached to a high-voltage electrical cable (such as the cable 280 shown in FIG. 2C). The bushing insert 231A is mounted to the top 224 of the housing 221 at a bushing well 233A.

FIG. 2C shows the OH transformer 220 mounted in the upper portion (near the top) of a support 210 in a utility system. The OH transformer 220 is a single-phase unit. The dead-front bushings 230A and 230B (connected to cable terminations in FIG. 2C) are the high voltage (HV) connections to the transforming apparatus inside the housing 221. The HV connections may be a phase-to-phase connection or a phase-to-ground connection. The three terminals 229 on the sidewall of the housing 221 are low-voltage output bushings. The low-voltage bushings may be used with relatively low voltages, such as, for example 120 V, 322 V, or 347V. The low-voltage bushings may be used with other voltages and the voltages provided are given as examples. In the example shown in FIG. 2C, there are three terminals 229. However, in other examples, the OH transformer may include a different number of low-voltage bushings, for example, two or four low-voltage bushings.

Other implementations are possible. For example, although the OH transformer 220 is a single-phase transformer, a three-phase OH transformer also may be implemented with dead-front bushings. The three-phase OH transformer 220 would be similar to the OH transformer 220 but would include three to six HV dead-front bushings instead of two, and three or four low-voltage bushings with a three-phase output. Furthermore, in single phase implementations, the OH transformer may have only one HV dead-front bushing instead of the two HV dead-front bushings shown in FIGS. 2A-2C.

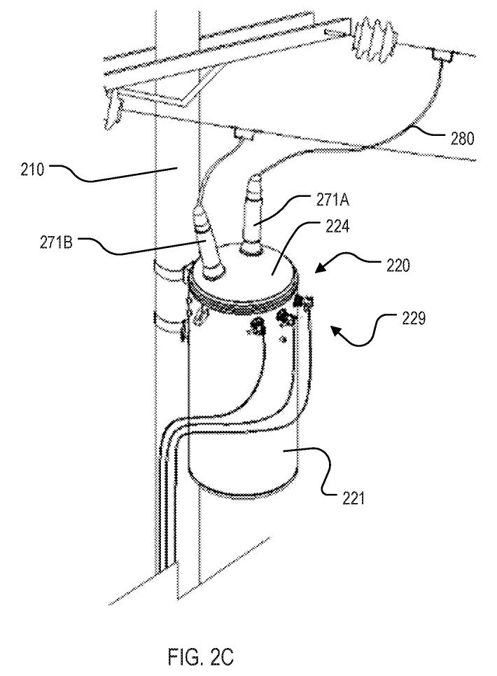

FIG. 3 is an exterior view of another OH transformer 320 and a cable system 370 that is attached to a bushing of the OH transformer. The cable system 370 is a pre-fabricated medium-voltage cable system that can be electrically connected to the transforming apparatus (not shown) in the interior of the OH transformer 320. The cable system 370 includes a sealed medium-voltage dead-front connection 371, an insulated medium-voltage cable 372, a high-voltage termination 373, and a hot-line stirrup clamp 374. The insulated medium-voltage cable 372 is attached to the dead-front connection 371 and the high-voltage termination 373. The insulated medium-voltage cable 372 may be a pre-cut, pre-terminated stinger wire. The dead-front connection 371 may be a V1 Posi-break style. The dead-front connection 371 may be fully insulated and fully dead-front or semi-dead-font. In the semi-dead-front implementation, the connection 371 may be sealed and covered with the stinger wire. The high-voltage termination 373 may be a high-voltage cable termination with a stress cone rated up to 35 kilovolts (kV).

The hot-line stirrup clamp 374 may be pre-installed on the high-voltage termination 373. The hot-line stirrup clamp 374 is used to connect the electrical conductor in the cable 372 to an overhead line (such as the overhead line 134 shown in FIG. 1). To connect the conductor to the overhead line, the stirrup clamp is clamped or otherwise attached to the overhead line. The clamp may be a C-clamp or a screw clamp made of metal with a threaded portion that, when twisted, closes the clamp around the overhead line to secure it.

The cable system 370 ensures safe, reliable, and quick installation of a single-phase over-head transformer (such as the OH transformer 320). Once installed, the cable system 370 mitigates the risk to wildlife and reduces the risk of fire.

Other implementations are possible. For example, the cable system 370 may be implemented without the hot-line stirrup clamp 374.

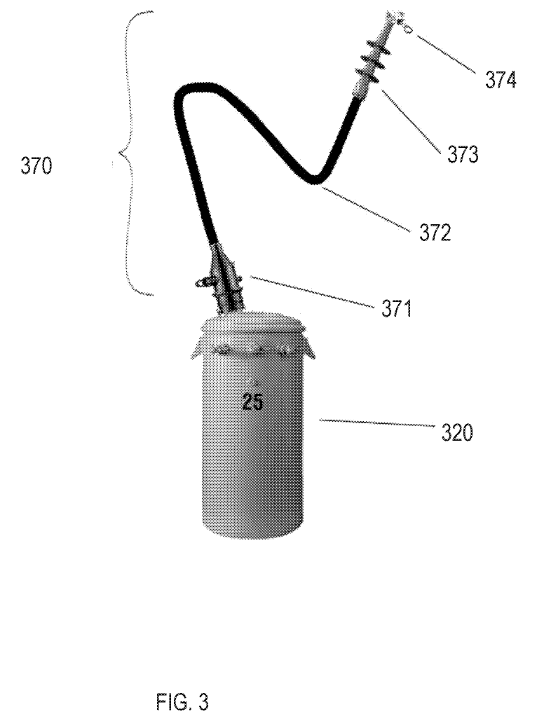

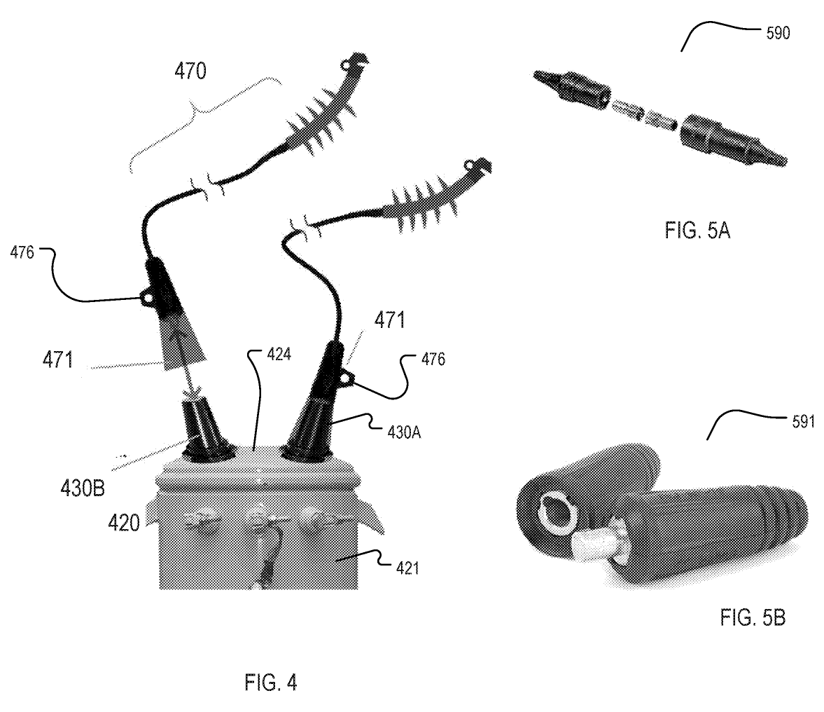

FIG. 4 is a partial exterior view of an upper portion of another OH transformer 420. The OH transformer 420 includes a housing 421 with a top 424 and dead-front bushings 430A and 430B that extend from the top 224. A cable system 470 is attached to each bushing 430A and 430B. The cable system 470 is shown as being disconnected from the bushing 430B and connected to the bushing 430B. The cable system 470 is similar to the cable 370 of FIG. 3, except the cable 470 includes a connector 471 that includes a feature 476 configured to interact with a hotstick. The feature 476 may be, for example, a tab or a loop. Additionally, the connector 471 is a quarter turn dead-break interface that can be installed onto the bushing 430A or 430B on-site. For example, one of the cables 470 can be attached to each of bushing 430A and 430B in a bucket truck. The quarter turn dead-break interface may be based on quarter turn welding connectors, such as the connectors 590 and 591 shown in, respectively, FIGS. 5A and 5B. Other connectors may be used. For example, the connector 471 may be a 600/900amp dead-break connector, a 200amp dead-break with bail, or a 200amp load-break connector. The connector 471 may be any connector based on or complying with the standard of IEEE 386.

These and other implementations are within the scope of the claims.

What is claimed is:

1. An overhead transformer comprising:
a housing that defines an interior;
at least one dead-front bushing that is accessible from an exterior of the housing, the dead-front bushing comprising an electrically insulating cover that surrounds an electrical conductor; and
a transforming apparatus in the interior, the transforming apparatus electrically connected to the electrical conductor.

2. The overhead transformer of claim 1, wherein the overhead transformer is a single-phase transformer comprising at least one dead-front bushing accessible from the exterior of the housing.

3. The overhead transformer of claim 1, wherein the overhead transformer is a multi-phase transformer comprising more than two dead-front bushings accessible from the exterior of the housing.

4. The overhead transformer of claim 1, further comprising one or more components configured for high-voltage operation in the interior.

5. The overhead transformer of claim 4, wherein the components configured for high-voltage operation comprise one or more of an arrester and a fuse.

6. A cable assembly comprising:
a dead-front connector configured to mechanically and electrically connect to a bushing on an overhead transformer; and
an electrical cable electrically connected to the dead-front connector and to a voltage termination.

7. The cable assembly of claim 6, further comprising an attachment device configured to attach the voltage termination to an overhead power line.

8. The cable assembly of claim 7, wherein the attachment device comprises a hot-line stirrup clamp connected to the voltage termination.

9. The cable assembly of claim 6, wherein the voltage termination comprises a high-voltage stress cone.

10. The cable assembly of claim 6, wherein the dead-front connector comprises a quarter-turn connector.

11. The cable assembly of claim 6, wherein the dead-front connector comprises a dead-break connector.

12. The cable assembly of claim 6, wherein the dead-front connector comprises a feature configured to interact with a hotstick.
